(19) United States
(12) Patent Application Publication
(10) Pub. No.: US 2005/0062986 A1
(43) Pub. Date: Mar. 24, 2005

(54) Color level adjusting module and method thereof

(76) Inventors: Che-Hung Hu, Taipei (TW); Chun-Wu Chu, Taipei (TW)

Correspondence Address: HARNESS, DICKEY & PIERCE, P.L.C., P.O. BOX 8910, RESTON, VA, 20195, US

(21) Appl. No.: 10/668,256

(22) Filed: Sep. 24, 2003

(51) Int. Cl. H04N 1/52; H04N 1/60

(52) U.S. Cl. 358/1.9; 358/1.15; 358/523; 358/3.06

(57) ABSTRACT

The specification discloses a color level adjusting module and the method thereof. A data buffer unit stores image data sent from a data processing device. A look-up-table operating unit converts the data into printing data. A selector distributes the printing data and sends them to a print queue. The module solves the problem that different chipsets have to be used for different printing modules. Only a single module is needed. Therefore, the production cost can be greatly reduced.

### BACKGROUND OF THE INVENTION

1. Field of Invention

The invention relates to a color level adjusting module and the method thereof. More particularly, the invention pertains to a color level adjusting module applicable for parallel type or serial type printing devices and the method thereof.

2. Related Art

In recent years, electronic information products provide many functions that make human life more convenient than ever. The development in the semiconductor industry makes great use of application specific integrated circuits (ASIC's). Since the ASIC's have many different packaging styles and consume very little power, various printing devices use such ASIC's to reduce the product sizes while at the same time enhancing the product efficiency. Users can use a data processing device, such as the desktop computer and notebook computer, to print image or text information through a link to a printing device.

The conventional printing method is performed by sending data from a host to a printing device via a transmission port. However, there are parallel type and serial type printing modules on the market. Therefore, the prior art has to use the corresponding ASIC's and a look-up-table operating unit to make data conversions. In view of these problems, people in the field have been looking very hard for possible solutions. After all, expensive production costs are fatal drawbacks of the industry and are hard to be accepted by users.

### SUMMARY OF THE INVENTION

The invention provides a color level adjusting module and the method thereof to convert and transmit image data to a printing module. A data buffer unit is used to temporarily hold image data transmitted from the data processing device. A look-up-table operating unit converts the image data into printing data. A selector distributes the printing data. A displacement unit transmits the printing data according to predetermined operation clocks. Finally, a data integrating transmission unit transmits the printing data to the printing module. The look-up-table operating unit contains several address data and several corresponding conversion data. The address data and the conversion data are both composed of binary codes.

The disclosed color level adjusting method includes the following steps. First, image data to be printed are retrieved from an information processing device, such as a personal computer. The image data are compiled and processed for half-tone conversion. The image data are then stored. A table look-up operation is performed to convert the image data into printing data. Finally, the printing data transmission is performed according to the types of printing modules.

The prior art has to use two different ASIC's and look-up-table units for parallel type and serial type printing modules, resulting in high production costs. The disclosed color level adjusting module and the method thereof integrate the image data conversion and transmission operations into a single color level adjusting module. A single look-up-table unit is employed to convert image data. The invention is thus able to reduce production costs and makes the products more competitive.

### BRIEF DESCRIPTION OF THE DRAWINGS

The invention will become more fully understood from the detailed description given hereinbelow illustration only, and thus are not limitative of the present invention, and wherein:

FIG. 1 shows a system structure of the disclosed color level adjusting module;

FIG. 2 shows a schematic structure of the disclosed color level adjusting module;

FIG. 3 shows a schematic procedure flow of the disclosed color level adjusting method; and

FIG. 4 shows a schematic procedure flow of a detailed part in FIG. 3.

### DETAILED DESCRIPTION OF THE INVENTION

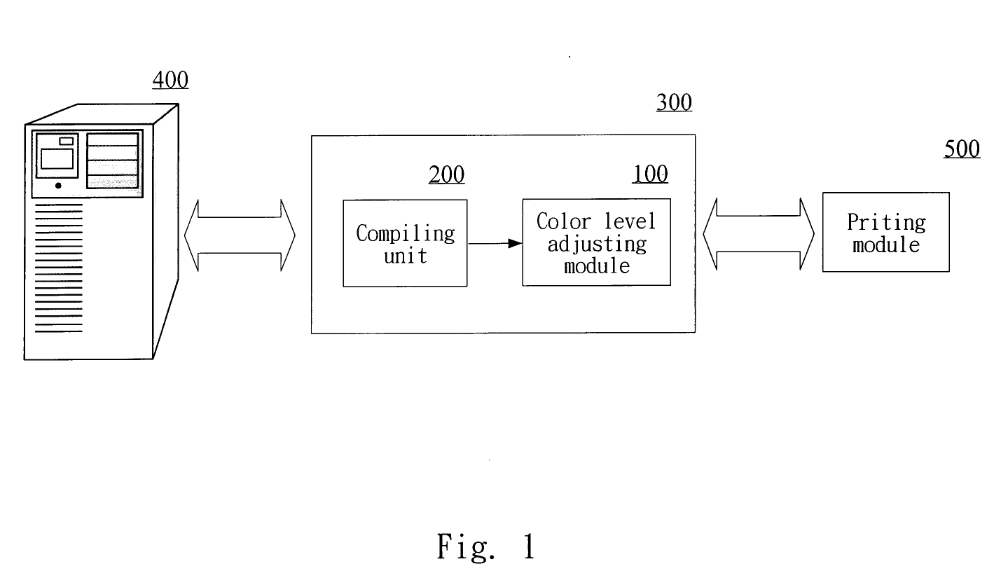

The disclosed color level adjusting module converts and transmits image data to a printing module. With reference to FIG. 1, the disclosed system includes:

(1) Information processing device 400: The user uses the information processing device 400 to process data and to send operating commands.

(2) Printing controller 300: It is used to perform conversion and transmission on the image data sent from the information processing device. It contains a compiling unit 200 and a color level adjusting module 100. The compiling unit 200 performs compilation and half-tone conversion processes on the image data.

(3) Printing module 500: It is used to receive data sent from the printing controller and to print the data. The printing module contains the parallel type and the serial type.

The printing controller 300 receives image data transmitted from the information processing device 400. The image data comprises text and picture information. The image data comprises also contains the color level property. The format of the image data is in accord with the printing command language.

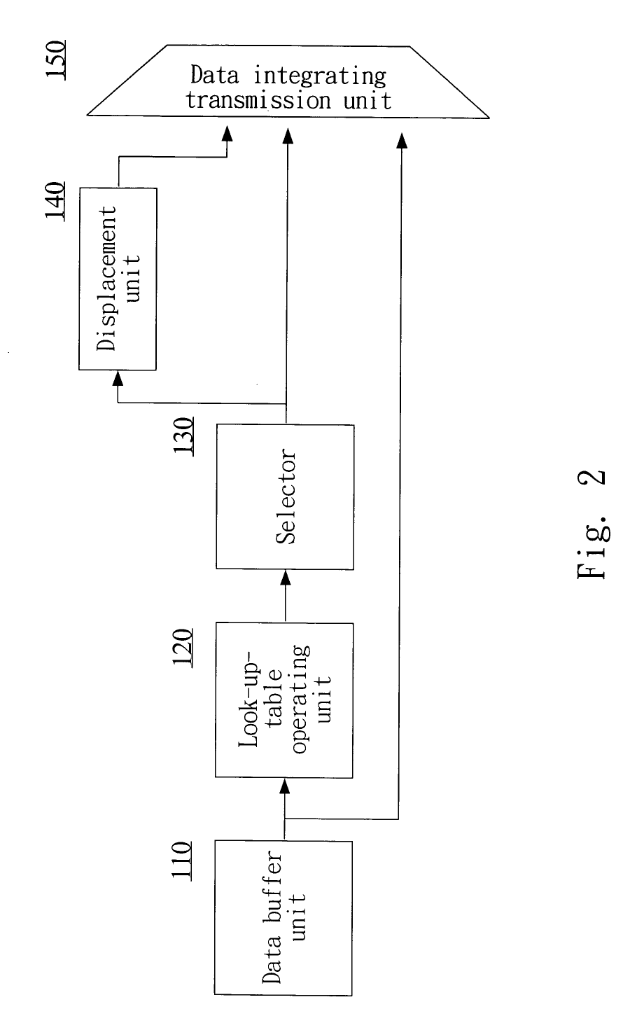

The essence of the invention is the color level adjusting module 100. FIG. 2 shows a structure of the disclosed color level adjusting module. As shown in the drawing, the color level adjusting module 100 mainly contain:

(1) Data buffer unit 110: It is used to temporarily hold image data transmitted from the information processing device 400.

(2) Look-up-table operating unit 120: It contains several address data and several corresponding conversion data. The address and conversion data are comprised of binary codes to convert the image data by looking up table. The image data are then converted into printing data with the color level property.

(3) Selector 130: It performs distribution processes according to the type of the printing module 500.

(4) Displacement unit 140: It transmits the printing data according to predetermined operation clocks.

(5) Data integrating transmission unit 150: It sends the printing data to a printing device.

The operation clocks in the displacement unit contain a dot clock and a video clock. The operation frequency of the image clocks is an integer multiple of the operation frequency of the dot clock.

It should be mentioned that if the type of the printing module 500 is parallel, then the process of using the look-up-table unit 120 can be selectively omitted. The image data are directly sent to the data integrated transmission unit 150. Alternatively, the image data can be distributed by the selector 130 before being sent to the data integrated transmission unit 150. If the printing module 400 is of the serial type, the printing data are displaced to the data integrated transmission unit 150 by the displacement unit 140. Afterwards, the image data are sent to the printing module 500 for printing.

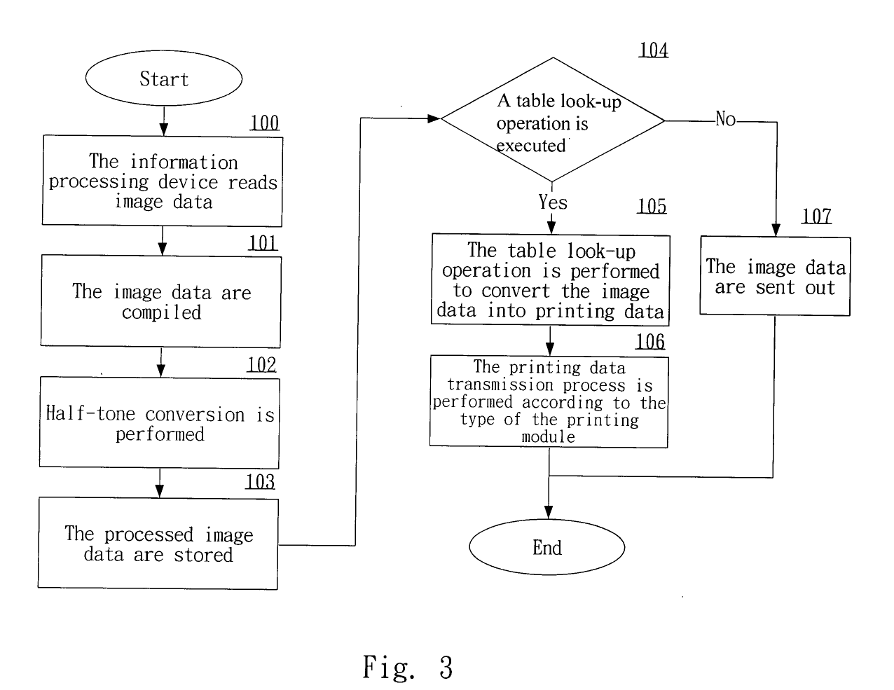

The actual operations of the above-mentioned are shown in FIG. 3. The disclosed method is invented for converting and transmitting image data to a printing module. First, the information processing device 500 reads image data (step 100). The image data are then compiled (step 101). Afterwards, half-tone conversion is performed (step 102). The processed image data are stored (step 103). A table look-up operation is then to be executed (step 104). At this moment, the system determines whether the table look-up operation can be omitted according to the type of the printing module 500. If it can be omitted, then the image data are sent out (step 107). If the image data have to be converted, then the table look-up operation is performed to convert the image data into printing data (step 105). The printing data transmission process is performed according to the type of the printing module 500 (step 106).

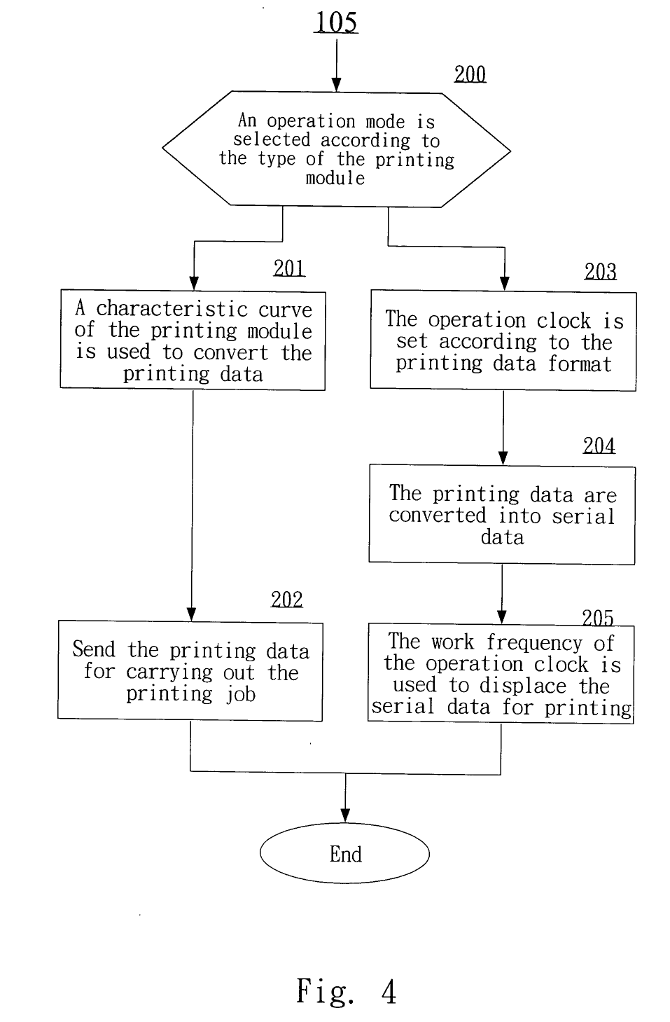

More detailed information about step 106 is shown in FIG. 4. First, an operation mode is selected according to the type of the printing module 500 (step 200). If it is a parallel type, then a characteristic curve of the printing module is used to convert the printing data (step 201) and to send the printing data for carrying out the printing job (step 202). If the printing module is a serial type, then the operation clock is set according to the printing data format (step 203). Afterwards, the printing data are converted into serial data (step 204). The work frequency of the operation clock is used to displace the serial data for printing (step 205).

Certain variations would be apparent to those skilled in the art, which variations are considered within the spirit and scope of the claimed invention.

1. A color level adjusting module for converting and transmitting image data to a printing module, comprising:
a data buffer unit, which receives and temporarily holds the image data;
a look-up-table operating unit, which coverts the image data into printing data;
a selector, which distributes the printing data;
a displacement unit, which transmits the printing data according to a predetermined operation clock; and
a data integrated transmission unit, which transmits the printing data to the printing module.

2. The color level adjusting module of claim 1, wherein the image data comprises text and picture information.

3. The color level adjusting module of claim 1, wherein the image data format is gauged by the printing command language.

4. The color level adjusting module of claim 1, wherein the type of the printing module is selected from parallel and serial.

5. The color level adjusting module of claim 1, wherein the image data have a color level property.

6. The color level adjusting module of claim 1, wherein the printing data have a color level property.

7. The color level adjusting module of claim 1, wherein the operation clock contains a dot clock and a video clock.

8. The color level adjusting module of claim 1, wherein the operation frequency of the video clock is an integer multiple of that of the dot clock.

9. The color level adjusting module of claim 1, wherein the look-up-table unit has a plurality of address data and a plurality of corresponding conversion data.

10. The color level adjusting module of claim 9, wherein the address data are comprised of binary codes.

11. The color level adjusting module of claim 9, wherein the conversion data are comprised of binary codes.

12. A color level adjusting method for converting and transmitting image data to a printing module, comprising the steps of:
reading the image data;
storing the image data;
performing a table look-up operation for the image data and converting the image data into printing data; and
performing a printing data transmission operation according to the type of the printing module.

13. The method of claim 12, wherein the printing data transmission operation is executed through a data integrated transmission unit.

14. The method of claim 12, wherein the image data comprises text and picture information.

15. The method of claim 12, wherein the type of the printing module is selected from parallel and serial.

16. The method of claim 12, wherein the image data have a color level property.

17. The method of claim 12, wherein the printing data have a color level property.

18. The method of claim 12, wherein the step of reading the image data further includes the step of compiling the image data and performing a half-tone conversion operation.

19. The method of claim 12, wherein the format of the image data is gauged by the printing command language.

20. The method of claim 12, wherein the step of transmitting the printing data includes the step of displacing in order the printing data to the printing module.

21. The method of claim 12, wherein the step of transmitting the printing data further includes the steps of:
using a characteristic curve of the printing module to convert the printing data; and
transmitting the serial data.

22. The method of claim 12, wherein the step of transmitting the printing data further includes the steps of:
setting an operation clock according to the format of the printing data;
converting the printing data into serial data; and
displacing in order the printing data according to the operation clock.
